(19) United States
(12) Patent Application Publication
(10) Pub. No.: US 2026/0175907 A1
(43) Pub. Date: Jun. 25, 2026

(54) SYSTEM AND METHOD FOR DETECTING STEERING COMPONENT FAILURES AND IMPLEMENTING FALLBACK STEERING CONTROL

(71) Applicant: CHINA AUTOMOTIVE SYSTEMS, INC., Wuhan City (CN)

(72) Inventors: Haimian CAI, Ann Arbor, MI (US); Yuchen LIN, Troy, MI (US); Tiancheng ZHANG, Sterling Heights, MI (US); Sanjar OBIDOV, Sterling Heights, MI (US)

(21) Appl. No.: 19/426,596

(22) Filed: Dec. 19, 2025

Related U.S. Application Data
(60) Provisional application No. 63/735,986, filed on Dec. 19, 2024.

(51) Int. Cl. B62D 5/04

(52) U.S. Cl. CPC B62D 5/0481; B62D 5/0463

(57) ABSTRACT

Systems and methods for controlling a vehicle steering system under a detected fault condition. When a failure is identified in a torsion bar, a torque-angle sensor, or an intermediate shaft, the processor selects a target angle from a signal source upstream of the failed component and a feedback angle from a source downstream of the failed component. An angle difference is computed and multiplied by a torsion-bar stiffness value to obtain an estimated input torque. The estimated torque is shaped through a hysteresis function to reduce overshoot and oscillation, and a motor command for a steering motor is generated based on the shaped torque to maintain controllable steering during the fault condition. When a torque value from a torque-angle sensor is used as the target source, a deviation angle equal to torque divided by torsion-bar stiffness is summed with a sensor angle to form the target angle.

### CROSS REFERENCE TO RELATED APPLICATIONS

This utility patent application claims the benefit of U.S. Provisional Patent Application No. 63/735,986, filed Dec. 19, 2024, the contents of which is incorporated herein by reference in its entirety.

### BACKGROUND OF THE INVENTION

### 1. Field of the Invention

A system and method for detecting and compensating steering system failures, including failures of a torsion bar, torque-angle sensor, intermediate shaft, or combinations thereof, in an electric power steering (EPS) or steer-by-wire steering system is provided.

### 2. Description of the Prior Art

Modern electric power steering (EPS) systems rely on multiple mechanical and electronic components to measure driver intent and provide steering assistance. Components such as torsion bars, torque-angle sensors, intermediate shafts, and steering-angle sensors must operate together to ensure stable steering performance. Failure of any one of these components may cause inaccurate torque estimation, incorrect steering-angle interpretation, or loss of mechanical coupling within the steering column.

Conventional EPS systems generally include basic sensor plausibility checks, but they typically lack comprehensive diagnostic mechanisms capable of identifying specific failures or distinguishing between failures of different components. For example, a torsion-bar fracture may cause unstable or implausible torque readings.

### SUMMARY OF THE INVENTION

The present disclosure provides a method for controlling a steering system of a vehicle. The steering system including a torsion bar, a torque-angle sensor mechanically coupled to the torsion bar, and a steering motor. The method includes: receiving, by a processor, a sensor signal from the torque-angle sensor, wherein the sensor signal includes a torque value corresponding to torque applied to the torsion bar and an angle value corresponding to angular deflection of the torsion bar; determining, by a processor, that a fault condition has occurred in the steering system based at least on the sensor signal; retrieving, by the processor, a torsion bar stiffness value representing a relationship between torque applied to the torsion bar and angular deflection of the torsion bar; computing a deviation angle based on the torque value and the torsion-bar stiffness value; computing a target angle as a sum of the deviation angle and the angle value from the torque-angle sensor; selecting a feedback angle approximate to the angle value from the torque-angle sensor; computing a corrected torque value based on a difference between the target angle and the feedback angle and the torsion-bar stiffness value; and generating, by the processor, a motor command for the steering motor based on the corrected torque value, wherein the corrected torque value is used in place of a torque command derived directly from the torque value to control the steering motor.

The present disclosure also provides a steering system for a vehicle. The system includes: a torsion bar configured to transmit torque between a steering input and a steering output; a torque angle sensor coupled to the torsion bar and configured to generate a torque value corresponding to torque applied to the torsion bar and an angle value corresponding to angular deflection of the torsion bar; an additional steering angle sensor positioned upstream of the torsion bar and configured to generate a upstream angle value representing a rotational position of a steering component located upstream of the torsion bar; a steering motor configured to provide steering assist torque; and a processor operatively coupled to the torque angle sensor, the additional steering angle sensor, and the steering motor, wherein the processor is configured to: determine that a fault condition has occurred in the steering system, select the upstream angle value from the additional steering angle sensor as a target angle representing an estimated steering position of the upstream steering component, select the angle value as a feedback angle representing the angular deflection of the torsion bar and an estimate of driver applied steering input, compute an angle error based on a difference between the target angle and the feedback angle, and generate a motor command for the steering motor based on the computed angle error, wherein the command signal is configured to operate the steering motor to reduce the angle error and maintain steering control during the fault condition.

The present disclosure also provides a steering system for a vehicle. The system includes: A steering system for a vehicle, comprising: a plurality of steering sensors configured to generate sensor signals indicative of steering behavior; a steering actuator configured to provide steering assistance; a processor connected to the plurality of sensors and the steering actuator, wherein the processor is configured to: acquire sensor signals from the steering sensors, determine that a fault condition has occurred in the steering system based on the sensor signals, select, in response to determining the fault condition has occurred, a steering assist compensation strategy from a plurality of predefined compensation strategies; compute a control value based on at least one sensor information associated with the selected compensation strategy, and generate a command signal for the steering actuator based on the computed control value, such that the steering system maintains controllable steering behavior during the fault condition.

The present disclosure provides a method for controlling a vehicle steering system under a detected fault condition. A processor receives steering sensor signals and, upon determining that a fault has occurred, selects a target angle from a signal source located upstream of a failed component and selects a feedback angle from a signal source located downstream of the failed component. The processor retrieves a torsion-bar stiffness value, computes an angle difference between the target angle and the feedback angle, and obtains an estimated input torque as a product of the angle difference and the torsion-bar stiffness value. The estimated input torque is shaped through a hysteresis function to reduce overshoot and oscillation, and a motor command for a steering motor is generated based on the shaped torque to maintain controllable steering during the fault condition.

The present disclosure further provides a steering system including a torsion bar, a torque-angle sensor, a motor-resolver angle sensor, an upstream angle sensor positioned between an intermediate shaft and the torsion bar, and a steering motor. A processor is configured to detect a fault condition, select a target angle from an upstream signal source and a feedback angle from a downstream signal source according to the location of a failed component, compute an estimated input torque as a product of an angle difference and a torsion-bar stiffness value, shape the estimated torque through a hysteresis function, and generate a motor command for the steering motor based on the shaped torque to maintain steering control during the fault condition.

The present disclosure also provides a steering system comprising a plurality of steering sensors and a steering actuator, wherein a processor acquires sensor signals, determines that a fault condition has occurred, selects a steering-assist compensation strategy from predefined modes, computes a control value based on sensor information associated with the selected strategy, and generates a command signal for the steering actuator based on the computed control value such that the steering system maintains controllable steering during the fault condition.

### Advantages of the Invention

The invention, in its broadest aspect, provides a system and method for detecting, classifying, and compensating failures in a steering system that includes a torsion bar, torque-angle sensor, intermediate shaft, and multiple steering-angle sensors. The system and method of the present disclosure offer several advantages over conventional electric power steering systems. First, the invention provides a comprehensive diagnostic framework capable of identifying a wide range of steering-system failures, including multicomponent failures that conventional systems cannot reliably detect. Second, the invention enables seamless transition to an appropriate fallback steering-control mode, such as angle-control, virtual torque-control, or ADAS-based control, thereby maintaining stable and predictable steering assistance even when one or more steering components fail. Third, the system continuously evaluates sensor validity and updates steering control behavior in real-time, ensuring robust fail-operational performance while the steering system is in active use during vehicle operation.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 shows a steering assembly, in accordance with the present disclosure.

FIG. 2 shows a steering gear of the steering assembly of FIG. 1, in accordance with present disclosure.

FIG. 3A shows a steering system arrangement, in accordance with an aspect of the present disclosure.

FIG. 3B shows the steering system arrangement of FIG. 2A further including an additional angle sensor, in accordance with an aspect of the present disclosure.

FIG. 3C shows the steering system arrangement of FIG. 2B further including a clock spring/steering wheel angel sensor and an advanced driver-assistance system (ADAS) module, in accordance with an aspect of the present disclosure.

FIG. 4 shows a block diagram of an example method for controlling the steering assembly, in accordance with an aspect of the present disclosure.

### DESCRIPTION OF THE ENABLING EMBODIMENTS

Referring now to the Figures, wherein like numerals identify corresponding parts throughout the several views, embodiments of the present disclosure relate to systems and methods for detecting, classifying, and compensating steering-related failures within an electrical power steering (EPS) assembly. The systems and methods described herein may be implemented in a variety of steering architectures, including column-assist EPS systems, rack-assist EPS systems, and steer-by-wire (SWM) configurations. Modern EPS systems rely on multiple coordinated mechanical components and electronic sensors to ensure stable and predictable steering behavior. However, degradation or failure of any one or these components may result in instability, loss of steering assist, or an incorrect interpretation of the steering intent of the driver. The present disclosure provides a real-time, multi-layered redundancy framework configured to identify such failures and transition the steering system into a corrective operating mode to maintain safe vehicle control.

In general, steering assemblies of the type shown herein may include a torsion bar that twists in response to driver-applied torque, one or more torque-angle sensors (TAS) configured to measure torsional deformation, an input shaft, an intermediate shaft, and one or more angle sensors positioned at the steering motor or steering gear. As will be described below, systems and methods of the present disclosure employ multiple sensing elements arranged in different locations along the steering column to provide overlapping and cross-correlated measurement of steering torque and angle. By continuously monitoring these signals and comparing them to expected mechanical relationships, the present disclosure enables real-time identification of torsion bar failure, TAS failure, intermediate shaft disconnection, and combinations thereof.

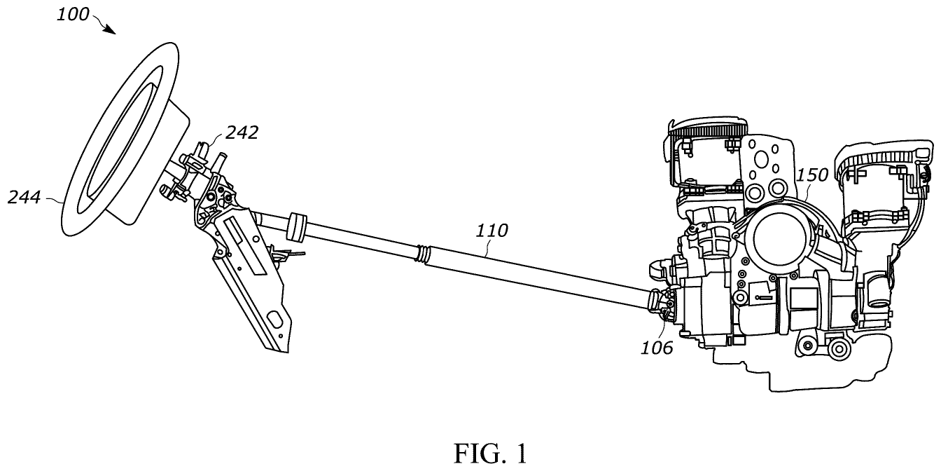

FIG. 1 illustrates a steering assembly 100 of the present disclosure. The steering assembly 100 includes a handwheel 244, a steering wheel angle sensor 242, an intermediate shaft 110, an input shaft 106, and a steering gear 150. The handwheel 244 is configured to receive rotational input from a driver and transmit the rotational input through the steering column to the intermediate shaft 110. The steering wheel angle sensor 242 is coupled to the handwheel 244 via a clock-spring and is configured to generate an upstream steering angle signal indicative of the rotational position of the handwheel 244 for use by electronic control functions. The intermediate shaft 110 provides a mechanical linkage between the handwheel 244 and the input shaft 106 and is configured to transmit torque and angular motion downstream. The input shaft 106 couples the intermediate shaft 110 to the steering gear 150 and delivers the upstream mechanical input into the steering gear 150.

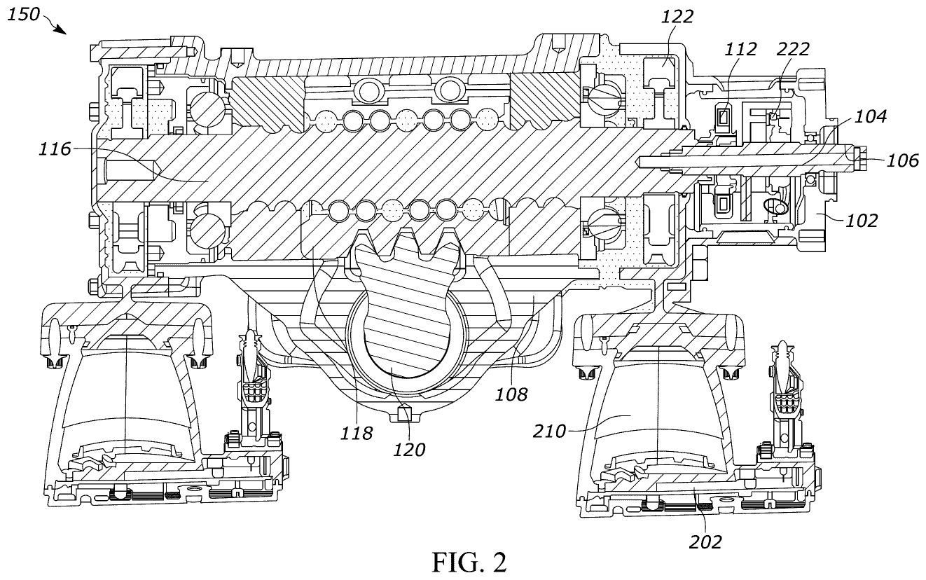

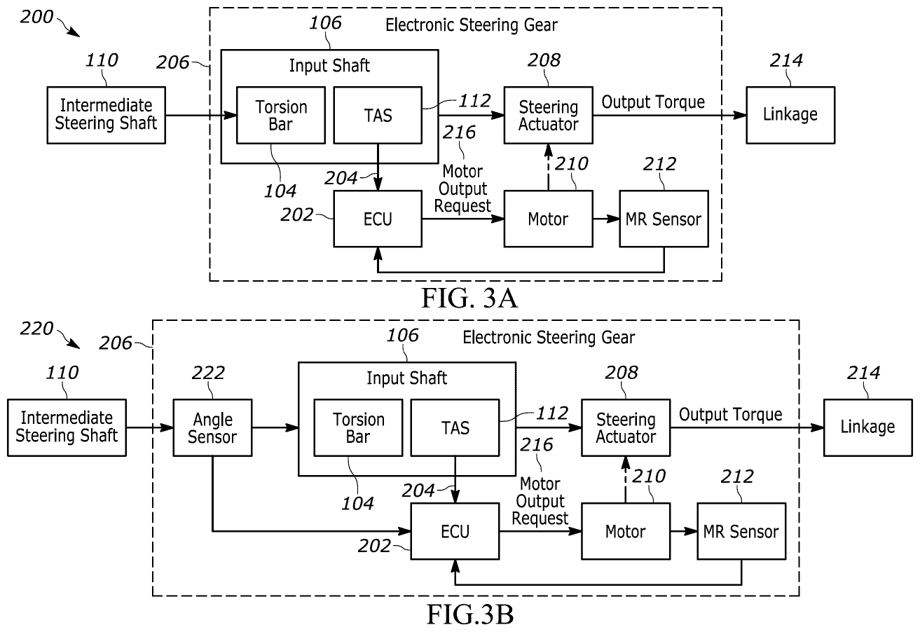

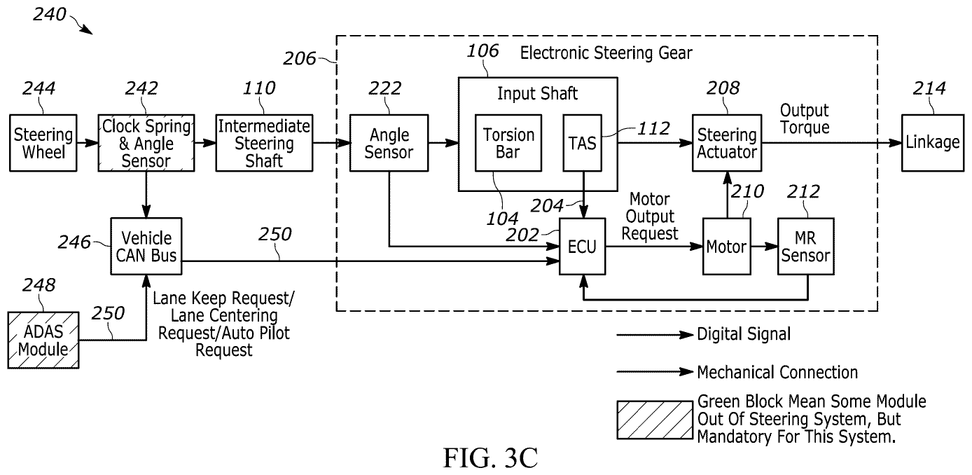

FIG. 2 is a sectional view of the steering gear 150 of the present disclosure. The steering gear 150 includes an input shaft 106 that receives rotation from the upstream steering column. A torsion bar 104 elastically couples the upstream input to the downstream gear train and, through its twist, drives a worm 122 and a screw shaft 116. A screw nut 118 advances along the screw shaft 116 and transmits force to a sector gear 120, which converts the linear motion into rotary output at an output interface of the gear. A torque-angle sensor (TAS) 112 is operably coupled to the input shaft 106 and to a portion of the torsion bar 104 and is configured to measure the relative angular displacement across the torsion bar 104, thereby providing a torque signal proportional to torsional deformation and an angle signal indicative of twist. The TAS 112 may include dual sensing channels to allow cross-checking of sensor validity. In some embodiments, a motor resolver (MR) sensor 212 (depicted in FIGS. 3A-C) or external steering angle sensor may be positioned downstream of the intermediate shaft 110, proximate to the steering motor 210 or the steering gear 150, to measure an actual steering output angle. The MR sensor 212 is positioned proximate to the steering motor 210 or within the steering gear 150 to measure a steering angle. The assembly is enclosed under an upper cover 102 and an intermediate housing 108 that serves as a structural enclosure without transmitting force. The torque signal and angle signal from the TAS 112, together with the downstream angle from the motor-resolver sensor 212 are communicated over a digital communication path 204 (depicted in FIGS. 3A-C) to an electronic control unit (ECU) 202.

FIG. 3A illustrates a first steering system arrangement 200 of the present disclosure. The arrangement 200 includes the torsion bar 104, the input shaft 106, and the TAS 112. The TAS 112 communicates torque and angle signals to an ECU 202 via a digital communication path 204. The ECU 202 is operably coupled to an electronic steering gear 206, which includes a steering actuator 208 and an electric motor 210. A motor-side MR angle sensor 212 is positioned to detect a steering output angle of the motor 210 and communicate this output angle to the ECU 202. Torque from the input shaft 106 is transmitted to steering actuator 208 through the intermediate shaft 110 and a mechanical linkage 214. The ECU 202 generates a motor output request 216 that drives the electric motor 210 based on one or more sensor inputs and a selected control strategy.

FIG. 3B illustrates a second steering system arrangement 220 of the present disclosure. The arrangement 220 includes the components of FIG. 3A and further comprises an additional angle sensor 222 upstream the torsion bar 104 and downstream the intermediate shaft 110. The additional angle sensor 222 provides a redundant measure of steering input angle and allows the ECU 202 to verify the accuracy of the MR sensor 212. This redundancy supports detection of torque-angle sensor failure (FC2), where the correlation between upstream and downstream angles becomes inconsistent. The ECU 202 may dynamically select between MR sensor 212 and additional angle sensor 222, or fuse their readings, based on sensor validity and the detection methods described herein.

FIG. 3C illustrates a third steering system arrangement 240 of the present disclosure. The arrangement 240 includes the elements of FIGS. 3A and 3B and further includes a steering wheel angle sensor 242. The steering wheel angle sensor 242 may be mounted to a handwheel 244 via a clock-spring assembly 242 to measure an input-side steering angle. The steering wheel angle sensor 242 may communicate with the ECU 202 via a vehicle communication bus 246, such as a CAN bus. In some embodiments, the ECU 202 compares the handwheel-side angle with the downstream angles measured by the MR sensor 212 and the additional angle sensor 222 to determine whether an intermediate shaft 110 failure (FC3) has occurred. The arrangement 240 further includes an advanced driver-assistance system (ADAS) module 248 configured to generate steering control requests, such as lane-keep, lane-centering, or autopilot commands. The ADAS module 248 provides a target steering angle request 250 or a target torque request to the ECU 202. In response to detecting one or more fault conditions (FC), the ECU 202 may transfer steering control authority to the ADAS module 248 or may operate in a combined fallback mode using one or more of the sensors 212, 222, 242, as appropriate.

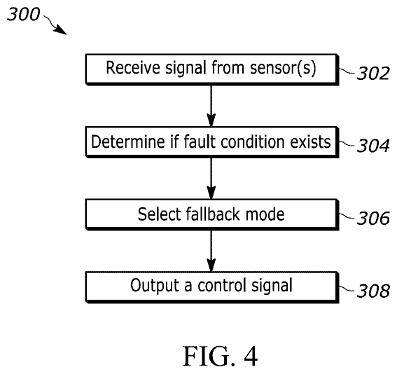

FIG. 4 is an example method 300 for operating a steering system. One or more steps of the method 300 can be performed by the ECU 202, in accordance with some embodiments of the present disclosure.

The method 300 begins at 302, where the ECU 202 receives input signals from a plurality of steering-related sensors associated with the steering gear assemblies 200, 220, and 240. In some embodiments, as depicted in FIG. 2A, the sensors include the TAS 112 and the MR sensor 212. In some embodiments, as depicted in FIG. 2B, the sensors include the TAS 112, the MR sensor 212, and the additional angle sensor 222. In some embodiments, as depicted in FIG. 2C, the sensors include the TAS 112, the MR sensor 212, the additional angle sensor 222, and the steering wheel angle sensor 242. In some embodiments, different combinations of sensors may be used, and the specific arrangement of sensors may vary depending on the steering architecture.

At 304, the method 300 includes determining whether a FC is present based on the validated sensor signals. In some embodiments, the FC comprises a torsion bar 104 failure (FC1). The ECU 202 identifies FC1 by detecting a torsion bar failure using detection method 1 (DM1). DM 1 includes detecting an implausibly large torque value TAS_{B} from the TAS 112, an abnormal rate of torque change, or steering-angle oscillations inconsistent with normal torsion-based elasticity based on the TAS 112 torque readings.

For example, where the torsion bar 104 is broken, but the TAS 112 is normally working, the TAS 112 receives a high torque value during driver manipulation. The high torque reading causes the motor 210 to overshoot. For example, when a 1 Nm input torque is applied to the steering wheel in a clockwise direction, but TAS 112 read out 15 Nm as it hits the torsion bar 104 limiter in a very short time, the motor 210 provides max output to clockwise direction causing an overshoot. The fractured torsion bar 104 will hit the other side of the limiter and cause the TAS 112 to read −15 Nm of steering torque, such that the motor 210 outputs maximum assistance in the counter-clockwise direction. By DM1, when the torque value oscillates repeatedly at a high frequency, the torque is very high, and the torque reaches a threshold value a number of times, the torsion bar is considered broken.

DM1 may use one or more signals including a torque value (TAS_{A}) and an angle value (TAS_{B}) from the TAS 112, a steering-wheel angle θ_{sw}, a rack angle θ_{rack}, and a motor angle θₘᵣ. In some embodiments, the signals may be sampled at a sampling frequency fs (e.g., 1000 Hz) and may be processed using a low-pass filter having a cutoff frequency f_lp to remove high frequency noise from the torque and angle signals.

In some embodiments, the ECU 202 monitors the filtered signals to detect an instability signature indicative of torsion bar 104 degradation or fracture. A counter and timer (e.g., 100 ms) may be initialized to track the occurrences of unstable assist behavior. For example, when the absolute value of the steering wheel torque exceeds an instability torque threshold, the timer may be started. If the steering wheel torque subsequently reverses direction and again exceeds the instability torque threshold within a time interval shorter than an instability timer threshold, the counter is incremented by one and the timer is reset to 0. Otherwise, the counter and time may be reset. If the counter reaches or exceeds a predetermined count threshold, a torsion bar failure is declared (e.g., when the counter exceeds 5).

In some embodiments, the FC comprises a TAS 112 failure (FC2). The ECU 202 identifies FC2 using detection method 2 (DM2), which includes determining that both channels of the TAS 112 fail a plurality of periodic validation checks, when the TAS 112 signal becomes implausible, or when TAS 112 angle values diverge from motor-side or downstream angles provided by the MR sensor 212.

In some embodiments, DM2 is configured to detect a failure of the TAS 112, such as a loss of signal integrity, invalid range behavior, or a loss of communication on one or more TAS 112 channels. The ECU 202 may receive torque and angle values from redundant TAS 112 channels (e.g., TAS_{A} and TAS_{B}), along with internal diagnostic information provided by the TAS 112, including cyclic redundancy check (CRC) values, range and offset diagnostics, and end to end (E2E) protection codes. The ECU 202 may periodically perform a validity check of the incoming TAS 112 data at a predetermined diagnostic interval.

In some embodiments, channel level validity rules may be applied to determine whether the torque or angle measurements fall within allowable operating limits. For example, the ECU 202 determines that a TAS 112 channel is invalid if a measured torque or angle value falls outside a predefined minimum-maximum range or if a CRC value indicates a communication error for more than a predetermined percentage of frames within a diagnostic window. In some embodiments, cross-channel plausibility checks may be performed by comparing the torque values from TAS_{A} and TAS_{B} and determining whether the absolute difference between the channels exceeds a plausibility threshold for longer than a persistence interval. If any of the range checks, CRC checks, or cross-channel plausibility conditions indicate that the TAS 112 is behaving abnormally, the ECU 202 may classify the condition as the TAS 112 failure.

In some embodiments, the FC comprises an intermediate shaft 110 failure (FC3). The ECU 202 identifies FC3 using detection method 3 (DM3), which includes determining that an upstream steering-wheel angle measured by the steering wheel angle sensor 242 mismatches a downstream steering angle measured by the MR sensor 212 or additional angle sensor 222. A mismatch exceeding a predetermined threshold over a defined observation window is indicative of loss of mechanical coupling through the intermediate shaft 110.

In some embodiments, DM3 is configured to detect an intermediate shaft 110 failure by monitoring angular discrepancies between upstream and downstream steering components. The ECU 202 may receive a steering wheel angle value θ_{sw} from a clock-spring sensor, an angle value θ_{gear} from the TAS 112, a motor estimated gear angle value θ_{gear}, and, in some embodiments, an additional downstream steering angel sensor value θ_{gear} from the additional downstream steering angle sensor 222. The ECU 202 may use the signals to determine whether the rotation of the steering wheel 244 is correctly transmitted through the intermediate shaft 110 to the steering gear 206.

In some embodiments, an angle mismatch value e may be computed as the difference between the steering wheel 244 angle θ_{sw} and the downstream gear angle value θ_{gear} (e.g., derived from the TAS 112, the MR 212, or an additional steering angle sensor 222). Angle values may be used only when internal validity checks pass to ensure correctness. Once validated, the ECU 202 may monitor whether the absolute value of the angle mismatch exceeds a mismatch magnitude threshold for longer than a mismatch persistence level while the vehicle speed exceeds a predefined speed threshold. Persistent angle mismatch of sufficient magnitude indicates that the intermediate shaft 110 is not correctly transmitting torque or rotation, such as due to a partial mechanical disengagement or rotational slip. If the angle mismatch condition persists within a diagnostic decision window, the ECU 202 declares an intermediate shaft 110 failure.

In some embodiments, the FC comprises a simultaneous or sequential torsion bar 104 failure and a TAS 112 failure (FC4). The ECU 202 identifies FC4 using detection method 4 (DM4), which includes applying hierarchical logic to determine which failure occurred first and validates whether torque-based and angle-based relationships remain consistent across the TAS 112, the MR sensor 212, and the additional angle sensor 222. A combined FC4 condition is present when torsion-derived torque becomes implausible and TAS 112 channels fail validation.

In some embodiments, DM4 is configured to detect a combined failure condition in which both a torsion bar 104 failure (FC1) and a TAS 112 failure (FC2) are present. DM4 operates using a hierarchical decision structure that evaluates the outputs of DM1 and DM2, which may run in parallel. Because the torsion bar 104 failure detection of DM1 relies on the validity of TAS 112 signals, the order in which the FC1 and FC2 indicators are latched affects the appropriate interpretation of the combined failure.

In some embodiments, when a TAS 112 failure is detected first (e.g., DM1 fault output is latched), the ECU 202 may initially apply the torsion bar 104 related diagnostic decision and its corresponding fallback solution. During this, the TAS 112 validity checks performed by DM2 may continue in parallel. If a TAS 112 failure is subsequently detected after the torsion bar 104 failure, the ECU 202 may transition to a fallback solution that supports both FC2 and FC4, ensuring robust control even under cascading failure conditions.

In some embodiments, the FC comprises a combination of torsion bar 104 failure and intermediate shaft 110 failure (FC5). The ECU 202 identifies FC5 using detection method 5 (DM5), which includes detecting that the torsion bar 104 torque behavior is abnormal (FC1) and upstream and downstream angles are mismatched (FC3). The dual pattern indicates both loss of torsion bar integrity and loss of shaft coupling.

In some embodiments, DM5 is configured to detect a combined failure condition involving both torsion bar 104 failure (FC1) and an intermediate shaft 110 failure (FC3). DM5 operates using a hierarchical evaluation structure similar to DM4 and relies on the outputs of DM1 and DM3, which may run in parallel. Because a failure of the intermediate shaft prevents accurate interpretation of torsion bar 104 behavior, the order in which FC1 and FC3 are detected influences the appropriate classification of the combined failure.

In some embodiments, if the intermediate shaft 110 failure is detected first (e.g., DM3 indicator is latched), the diagnostic logic may determine that DM1 is no longer effective. The torsion bar 104 related instability signatures cannot be reliably interpreted when the rotational relationship between the steering wheel and the downstream steering gear is compromised. Therefore, the ECU 202 may treat FC1 and FC3 as a combined failure state and may select a fallback strategy that is compatible with handling both failure types. Since all solutions that address intermediate shaft 110 failures also support torsion bar 104 failures, FC5 may be active immediately upon detection of FC3.

In some embodiments, the FC comprises TAS 112 failure and intermediate shaft 110 failure (FC6). The ECU 202 identifies FC6 using detection method 6 (DM6), which includes detecting that the TAS 112 signals become invalid and, concurrently, motor-estimated angle derived from the MR sensor 212 or additional angle sensor 222 fluctuates inconsistently with the upstream steering wheel angle measured by the steering wheel angle sensor 242, indicating both incorrect torque-angle measurements and loss of mechanical linkage.

In some embodiments, DM6 is configured to detect a combined failure condition in which both a TAS 112 failure (FC2) and an intermediate shaft 110 failure (FC3) have occurred. The ECU 202 may execute DM2 and DM3 in parallel, continuously evaluating the integrity of the TAS 112 signals and the plausibility of the steering angle relationship between the steering wheel and the downstream steering gear components. Because neither FC2 nor FC3 depends on the other for validity, DM6 may rely on a logical conjunction of the outputs of DM2 and DM3 to determine whether the combined failure FC6 is present.

In some embodiments, the ECU 202 may classify FC6 only when both the TAS 112 failure indicator from DM2 and the intermediate shaft 110 failure indicator from DM3 are latched concurrently or within a predefined diagnostic window. Once both failure conditions are confirmed, the ECU 202 may transition to a fallback control strategy configured to accommodate loss of TAS 112 validity together with loss of mechanical transmission along the intermediate shaft 110.

In some embodiments, the FC comprises a combination of torsion bar 104 failure, TAS 112 failure, and intermediate shaft 110 failure. The ECU 202 identifies FC7 using detection method 7 (DM7), which includes hierarchical multi-failure logic evaluating the order of detection across the TAS 112, the MR sensor 212, the additional angle sensor 222, and the steering wheel angle sensor 242, and determines that torque, torque-angle, and upstream-downstream angle relationships are all invalid or inconsistent with one another. The determining step at 304 enables the ECU 202 to classify a FC as one of FC1 through FC7 based on the sensing architectures 200, 220, and 240 depicted in FIGS. 2A-C.

In some embodiments, DM7 is configured to detect a tripled failure condition in which a torsion bar 104 failure (FC1), a TAS 112 failure (FC2), and an intermediate shaft 110 failure (FC3) occur concurrently or in close succession. DM7 may operate using a hierarchical framework in which the diagnostic indicators of DM1, DM2, and DM3 run in parallel. Because each individual failure mode affects the interpretability of the others, DM7 leverages the presence of FC6 as prerequisite indicator of overlapping electrical and mechanical failures.

In some embodiments, when DM6 is tripped, indicating that both the TAS 112 failure (FC2) and the intermediate shaft 110 failure (FC3) are active, DM1 becomes ineffective because torsion bar 104 instability signatures cannot be reliably interpreted without valid TAS 112 signals or a mechanically intact connection between the steering wheel and the downstream steering gear. As a result, the detection of FC6 may be treated as implicitly indicating the presence of FC7, because any torsion bar 104 failure diagnostics that might have been captured by DM1 prior to DM6 becoming active would no longer be distinguishable from the compound failure state. Accordingly, once DM6 is latched, the ECU 202 may classify the condition as a triple failure (FC7) and may transition to a fallback steering control strategy compatible within simultaneous loss of torsion bar 104 integrity, TAS 112 validity, and intermediate shaft 110 mechanical transmission.

Upon detection of a fault condition, the steering system transitions into a special control mode that is activated to maintain controllable steering assist. The electronic control unit (ECU) 202 receives sensor signals from steering sensors including, in various embodiments, the TAS 112, the MR sensor 212, the upstream angle sensor 222 positioned between the intermediate shaft 110 and the torsion bar 104, and the handwheel angle sensor 242. The ECU 202 determines that a fault condition has occurred based at least on the sensor signals. The fault condition may comprise a torsion bar 104 failure, a TAS 112 failure, or an intermediate shaft 110 failure.

In response to determining the fault condition has occurred, the ECU 202 selects a target angle from a signal source located upstream of an identified failed component and selects a feedback angle from a signal source located downstream of the failed component. For example, when an intermediate shaft 110 failure is detected, the target angle may be selected from the handwheel angle sensor 242 and the feedback angle may be selected from the motor-resolver angle sensor 212. When a TAS 112 failure is detected, the target angle may be selected from the upstream angle sensor 222 and the feedback angle may be selected from the motor-resolver angle sensor 212. In some embodiments, the feedback angle may be selected from an independent downstream angle measurement, such as a motor-resolver (MR) angle sensor 212, a gear-side angle sensor, or, when valid, a TAS-derived angle. When a torsion bar 104 failure is detected, the target angle may be selected from a TAS-derived angle described below and the feedback angle may be selected from a downstream angle measurement such as the MR sensor 212. In some embodiments, expected torque and angle values are derived from calibrated mechanical relationships of the steering gear 150 (including K_{TB}) and from model-based predictors filtered by operating state, and diagnostic decisions are made when differences exceed predefined thresholds over a monitoring interval.

The ECU 202 retrieves a torsion-bar stiffness value K_{TB}representing the relationship between torque applied to the torsion bar 104 and angular deflection of the torsion bar 104. The ECU 202 computes an angle difference Δθ equal to a difference between the selected target angle θₜₐᵣ and the selected feedback angle θ_{fb}, where:

$$Δθ = {θ}_{tar} - {θ}_{fb}$$

The ECU 202 computes an estimated input torque Tₑₛₜ as a product of the angle difference and the torsion-bar stiffness value, where:

$${T}_{est} = Δθ \times {K}_{TB}$$

The ECU 202 applies a hysteresis shaping function to the estimated input torque Tₑₛₜ to obtain a shaped torque command configured to reduce overshoot and oscillation in closed-loop operation. The hysteresis shaping function is symmetric about the origin, maintains sign consistency between input and output, and reduces output more rapidly during decreasing input magnitude than it increases output during rising input magnitude, thereby damping oscillatory behavior associated with fault-induced dynamics. The ECU 202 generates a motor command for the steering motor 210 based on the shaped torque command to maintain controllable steering performance during the fault condition. In some embodiments, for equal magnitude inputs during increasing and decreasing sweeps of the estimated input torque, the hysteresis function yields a lower output torque during the decreasing sweep than during the increasing sweep.

In some embodiments, the target angle source comprises a torque value output by the TAS 112. When TAS torque is used as the target source, the ECU 202 computes a deviation angle equal to the torque value divided by the torsion-bar stiffness value and computes the target angle as a sum of the deviation angle and a relative angle value from the TAS 112, where:

$$Deviation angle = \frac{TAS torque}{{K}_{TB}} ;$$

$$Target Angle = Deviation angle + TAS Angle .$$

The feedback angle in such embodiments is selected from an independent downstream angle measurement, such as the motor-resolver angle sensor 212. Fault detection may be implemented using hierarchical diagnostics. A torsion bar failure is identified by detecting an instability signature in a measured torque signal including repeated threshold-exceeding sign reversals within a timer interval and declaring the torsion bar failure when a count threshold is met (e.g., the count threshold is 5). A TAS failure is identified by detecting invalid range behavior, loss of communication integrity, or cross-channel implausibility on redundant TAS channels over a persistence interval. An intermediate shaft failure is identified by detecting a persistent mismatch between an upstream steering angle (e.g., from the handwheel angle sensor 242 or the upstream angle sensor 222) and a downstream steering angle (e.g., from the motor-resolver angle sensor 212) exceeding magnitude and duration thresholds.

The foregoing special control mode operates within the steering gear arrangements introduced in FIGS. 3A-3C, and is compatible with angle-control and ADAS-based control modes when additional vehicle-level control is available. In all modes, the ECU 202 processes upstream and downstream angle signals, together with torque and relative angle signals from TAS 112 when valid, to ensure that selected target and feedback angles are derived from independent sensing paths separated by the failed component such that the computed angle difference reflects the fault-isolated steering state.

At 306, the method 300 includes selecting and executing a fallback steering control mode based on the FC identified at 304. The fallback steering control mode corresponds to the nature of the detected FC and the availability of valid steering-related signals in the steering assemblies 200, 220, and 240. In some embodiments, the fallback control mode comprises an angle-control mode. The ECU 202 selects the angle-control mode when the FC comprises a torsion bar 104 failure (FC1), a TAS 112 failure (FC2) or an intermediate shaft 110 failure (FC3), and valid downstream steering-angle measurements remain available from the MR sensor 212, the additional angle sensor 222, or the steering wheel angle sensor 242. In the angle-control mode, the ECU 202 selects a target steering angle (e.g., an angle value upstream the failed component) and a feedback steering angle (e.g., an angle value downstream the failed component) and generates a motor output based on angle error. In some embodiments, the target steering angle may be from the steering wheel angle sensor 242, from the additional angle sensor 222, or an angle calculated from the TAS 112 torque value. The TAS 112 torque value may be calculated as the addition between the TAS 112 angle value and the TAS 112 torque value divided by the torsion bar stiffness. In some embodiments, the target steering angle is from an angle upstream from the failed component. In some embodiments, the feedback steering angle may be from the additional angle sensor 222, the TAS 112 angle value, or an angle value estimated by the MR sensor 212. The ECU 202 executes the angle control mode by determining a target steering angle, determining a feedback steering angle from the MR sensor 212, additional angle sensor 222, or the steering wheel angle sensor 242, computing an angle error, and generating a steering motor command that reduces the angle error toward zero. In some embodiments, the feedback steering angle is from an angle downstream from the failed component.

In some embodiments, the ECU 202 selects the input signals specified by the active solution profile corresponding to the detected failure. Angle control may be implemented as a closed loop controller that uses two primary signals: a target angle θₜₐᵣ and a feedback angle θ_{fb} obtained from an independent sensing path. The ECU 202 may compute a tracking error e=θₜₐᵣ−θ_{fb} and generate a motor command that drives the steering actuator to reduce the tracking error and move the feedback angle toward the target angle. To ensure stable steering behavior under the degraded sensing conditions associated with the active failure mode, the ECU 202 may employ a dedicated fault mode angle control strategy that is separate from the ADAS angle control algorithm.

In some embodiments, the fault mode angle control strategy may include fault specific gain scheduling, reduced closed loop bandwidth, rate or torque saturation limits, anti-windup protection, and optional notch or damping filters to suppress oscillatory behavior. These modifications help maintain predictable and controllable steering performance while the failure condition persists. The angle control mode therefore provides a fallback mechanism that allows the steering system to continue operating safely even when primary sensing pathways have been compromised.

In some embodiments, the fallback control mode comprises a special torque-control algorithm. The ECU 202 selects the special torque-control algorithm when the fault condition includes a torsion bar 104 failure (FC1), a torsion bar 104 and a TAS 112 failure (FC4), or a torsion bar 104 and an intermediate shaft 110 failure (FC5), and direct torque measurement is unreliable due to torsion bar 104 or TAS 112 abnormalities. The ECU 202 executes the special-torque control algorithm by determining a target angle and feedback angle, and computing a virtual input torque:

$$Virtual input torque = ( target angle - feedback angle ) \times torsion bar stiffness ,$$

and generating motor torque commands corresponding to the computed virtual torque.

The special torque control algorithm utilizes a special hysteresis curve to reduce the impact of overshoot. In conventional control algorithms, a slight turn of the steering wheel generates significant motor assistance (e.g., 15 Nm to the right), leading to a smaller torque reading. The rightward torque decreases (e.g., to 10 Nm), a large amount of rightward torque output is provided, causing the system to accelerate continuously, resulting in severe overshoot and oscillation. The special torque control algorithm reduces motor output even with a slight decrease in torque. For example, when the torque drops from 15 Nm to 12 Nm, the motor 210 output approaches zero.

In some embodiments, the fallback control mode comprises an ADAS angle-control mode. The ECU 202 selects the ADAS angle-control mode when driver-input signals become unreliable due to a TAS 112 failure (FC2), an intermediate shaft 110 failure (FC3), a TAS 112 failure and an intermediate shaft 110 failure (FC6), or a TAS 112 failure, an intermediate shaft 110 failure, and torsion bar 104 failure (FC7), and the ADAS module 248 remains operational. The ECU 202 executes the ADAS angle-control mode by receiving an ADAS target angle request 250, measuring a steering system feedback angle, computing an ADAS angle error, and adjusting the steering actuator 208 to drive the steering gear 206 toward the ADAS-request angle using closed-loop feedback from the MR sensor 212, the additional angle sensor 222, and the steering wheel angle sensor 242.

In some embodiments, the ECU 202 receives an ADAS target angle request generated by an advanced driver assistance system (ADAS) module 248, which may derive the request from camera data, environmental perception algorithms, or other vehicle level sensing inputs. The ADAS target angle request may define a desired steering angle for lane following, lane changes, obstacle avoidance, or emergency maneuvers. The ECU 202 may also receive a steering system feedback angle from a downstream sensing path, such as the MR sensor 212 or another independent steering angle sensor.

In some embodiments, the ADAS angle control mode may be implemented as a closed loop controller in which the ECU 202 computes an angle error based on the difference between the ADAS target angle request and the steering system feedback angle. The ECU 202 may then generate a control signal to drive the steering actuator such that the feedback angle approaches the ADAS requested angle. In some embodiments, the ADAS angle control loop may incorporate ADAS specific tuning parameters, including bandwidth limitations, trajectory smoothing filters, anti-windup protection, and optional damping filters, to ensure stable vehicle behavior under dynamic roadway conditions.

Because the ADAS module 248 operates at the vehicle level, the steering system may also provide its current steering angle back to the ADAS module 248 to support closed loop lane control and trajectory adjustment. Using this mode, the system may execute ADAS assisted steering tasks such as lane centering, automated lane changes, and emergency steering events while ensuring that the vehicle remains controllable and responsive even when certain steering system components are degraded.

In some embodiments, the fallback control mode comprises an ADAS torque-control mode. The ECU 202 selects the ADAS torque-control mode when the FC affects both upstream steering-angle sensing and torque sensing, such as an intermediate shaft 110 failure (FC3), a TAS 112 failure and an intermediate shaft 110 failure (FC6), or a TAS 112 failure, an intermediate shaft 110 failure, and a torsion bar 104 failure (FC7), and when the ADAS module 248 provides a target torque request. The ECU 202 executes the ADAS torque-control mode by receiving an ADAS target torque request, determining downstream steering angle feedback, and adjusting steering-motor torque to track the ADAS-requested torque values while using downstream angle feedback for stability.

In some embodiments, the ECU 202 receives an ADAS target torque request generated by the ADAS module 248. The ADAS module 248 may compute the target torque request based on vehicle level perception inputs, such as camera derived lane information, roadway features, vehicle trajectory predictions, or obstacle avoidance algorithms. The steering system may also provide a steering system feedback angle to the ADAS module 248 to enable closed loop coordination between vehicle level planning and steering actuator execution.

In some embodiments, the ADAS torque control mode may utilize a torque error calculation module that determines a torque error based on the difference between an ADAS requested target torque and a torque value derived from steering system feedback, which may include an inferred or measured steering angle to torque relationship. The ECU 202 may then generate a motor torque command based on the torque error and drive the steering actuator to produce a steering assist torque that tracks the ADAS target torque command.

The ADAS torque control mode may include closed loop features tailored for ADAS operation, such as bandwidth reduction, torque rate limits, anti-windup protection, trajectory smoothing, and damping filters configured to maintain stable steering behavior under dynamic driving conditions. This mode allows the steering system to execute ADAS initiated torque commands for lane changes, lane centering, or emergency steering maneuvers, even when certain steering system components are degraded.

At 308, the method 300 includes outputting a control signal to operate the steering motor 210 based on the fallback control mode selected and executed at step 306. Outputting the control signal includes generating a motor output request 216 configured to actuate the steering actuator 208 and the electric motor 210 of the steering gear assemblies 200, 220, and 240 based on the motor output torque request from the fallback control modes.

The system, methods and/or processes described above, and steps thereof, may be realized in hardware, software or any combination of hardware and software suitable for a particular application. The hardware may include a general purposed computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for controlling a steering system of a vehicle, the steering system including a steering actuator and a plurality of steering sensors, the method comprising:
determining, by a processor, that a fault condition has occurred in the steering system;
identifying, based on the fault condition, a failed steering component of the steering system;
selecting, by the processor, a target angle from at least one of the steering sensors located upstream of the failed steering component;
selecting, by the processor, a feedback angle from at least one of the steering sensors located downstream of the failed steering component;
computing an angle difference between the target angle and the feedback angle;
retrieving, by the processor, a torsion-bar stiffness value of the steering system;
computing an estimated torque value based on a product of the angle difference and the torsion-bar stiffness value;
generating a motor command by applying the estimated torque value to a torque shaping function; and
outputting the motor command to the steering actuator.

2. The method of claim 1, wherein selecting comprises selecting a target signal from a steering angle sensor, an additional angle sensor, or a torque value from a torque-angle sensor (TAS).

3. The method of claim 2, wherein when the torque value is selected as the target signal, the method further comprises converting the torque value into an angle value by: computing a deviation angle by dividing the torque value by a torsion-bar stiffness value; and computing the target angle as a sum of the deviation angle and an angle value output by the TAS.

4. The method of claim 1, wherein selecting the feedback angle comprises selecting the feedback angle from an angle sensor, a torque-angle sensor (TAS), or a motor-resolver (MR) sensor.

5. The method of claim 1, wherein the target angle and the feedback angle are selected based on an identified type of the failed steering component.

6. The method of claim 1, wherein the torque shaping function exhibits hysteresis such that, for an equal magnitude of the estimated torque value during increasing input sweeps and decreasing input sweeps, an output torque during the decreasing input sweep is lower than an output torque during the increasing input sweep.

7. The method of claim 1, wherein determining the fault condition comprises:
determining a torque difference between the torque value and an expected torque value and determining the torque difference exceeds a torque-difference threshold;
determining a rate of change of the torque value and determining the rate of change exceeds a rate-of-change threshold; or determining an angle difference between an angle value of the TAS and an expected angle value and determining the angle difference exceeds an angle-difference threshold over a monitoring interval.

8. The method of claim 1, wherein determining that the fault condition has occurred comprises identifying a torsion bar of the steering system as the failed steering component by: monitoring a torque value generated by a torque-angle sensor (TAS);
initiating a timer when an absolute value of the torque value exceeds a torque threshold;
incrementing a counter when the torque value decreases and again exceeds the torque threshold; and
resetting the counter and the timer when the torque value remains consistent or increases during a monitoring interval.

9. The method of claim 8, wherein the torsion bar is declared as the failed steering component when the counter reaches or exceeds a predetermined count threshold.

10. The method of claim 1, wherein determining the fault condition comprises identifying an intermediate shaft of the steering system as the failed steering component based on a comparison between a steering wheel angle from a steering angle sensor of the steering sensors and at least one of the steering sensors located downstream of the intermediate shaft.

11. A steering system for a vehicle, comprising:
a steering actuator configured to apply steering assist to a steering mechanism;
a torsion bar mechanically coupled between a steering input and a steering output;
an intermediate shaft configured to transmit rotation between the steering input and the steering actuator;
a torque-angle sensor (TAS) mechanically coupled to the torsion bar and configured to generate a torque value and a torsion-bar angle value;
a motor resolver (MR) sensor configured to generate a steering angle value associated with the steering actuator;
a steering wheel angle sensor configured to generate a handwheel angle value;
an additional upstream angle sensor positioned between the intermediate shaft and the torsion bar and configured to generate an upstream steering angle value;
a processor electrically coupled to the TAS, the MR sensor, the steering wheel angle sensor, and the steering actuator, wherein the processor is configured to:
monitor the torque value from the TAS, the torsion-bar angle value from the TAS, the steering angle value from the MR sensor, the handwheel angle value from the steering wheel angle sensor, and the upstream steering angle value from the additional upstream angle sensor to detect a failed steering component from at least one of the torsion bar, the intermediate shaft, and the TAS,
identify the failed steering component based on a relationship between upstream steering signals and downstream steering signals,
select a target angle from at least one angle signal located upstream the failed steering component or from a calculated angle value derived from an upstream signal,
select a feedback angle from at least one angle signal located downstream of the failed steering components, and
control the steering actuator using the selected target angle and the selected feedback angle according to a predefined compensation control method such that the steering system maintains controllable steering behavior after detection of the failed steering components.

12. The steering system of claim 11, wherein the processor is configured to determine the failed steering components by determining a torque difference between a torque value generated by the TAS and an expected torque value and determining whether the torque difference exceeds a torque-difference threshold, determining a rate of change of the torque value and determining whether the rate of change exceeds a rate-of-change threshold, or determining an angle difference between an angle value generated by the TAS and an expected angle value and determining whether the angle difference exceeds an angle-difference threshold over a monitoring interval.

13. The steering system of claim 11, wherein the processor is configured to identify the torsion bar as the failed steering component by:
monitoring the torque value generated by the TAS,
initiating a timer when an absolute value of the torque value exceeds a torque threshold,
incrementing a counter when the torque value decreases and again exceeds the torque threshold within a monitoring interval, and
resetting the counter and the timer when the torque value remains consistent or increases during the monitoring interval.

14. A steering system for a vehicle, comprising:
a plurality of steering sensors configured to generate sensor signals indicative of steering behavior;
a steering actuator configured to provide steering assistance;
a processor connected to the steering sensors and the steering actuator, wherein the processor is configured to:
acquire sensor signals from the steering sensors,
determine that a fault condition has occurred in the steering system based on the sensor signals,
select, in response to determining the fault condition has occurred, a steering assist compensation strategy from a plurality of predefined compensation strategies;
compute a control value based on at least one sensor information associated with the selected steering assist compensation strategy, and
generate a command signal for the steering actuator based on the computed control value, such that the steering system maintains controllable steering behavior during the fault condition.

15. The steering system of claim 14, wherein the steering sensors comprise an advanced driver assistance system (ADAS) configured to output an ADAS target angle request and a motor-resolver (MR) angle sensor configured to output a downstream steering angle value used as a feedback angle.

16. The steering system of claim 15, wherein selecting the steering assist compensation strategy comprises selecting an ADAS angle control mode, wherein computing the control value for the ADAS angle control mode comprises: selecting the ADAS target angle request as a target angle, selecting the downstream steering angle value from the MR angle sensor as the feedback angle, and computing an ADAS angle error based on a difference between the target angle and the feedback angle, wherein generating the command signal for the ADAS angle control mode comprises generating the command signal for the steering actuator based on the ADAS angle error.

17. The steering system of claim 14, wherein the steering sensors comprise a torque angle sensor (TAS) configured to output a torque value corresponding to torque applied to a torsion bar and an angle value corresponding to angular deflection of the torsion bar.

18. The steering system of claim 17, wherein selecting the steering-assist compensation strategy comprises selecting a special torque control algorithm, wherein computing the control value for the special torque control algorithm comprises: selecting the torque value output by the TAS as a target torque input, selecting the angle value output by the TAS as a feedback angle, and computing a torque error based on a difference between the target torque input and the feedback angle, wherein generating the command signal for the special torque control algorithm comprises generating the command signal for steering actuator based on the torque error.

19. The steering system of claim 14, wherein the steering sensors comprise a downstream steering angle sensor configured to output a downstream steering angle value and a torque angle sensor (TAS) configured to output a TAS angle value.

20. The steering system of claim 19, wherein selecting the steering assist compensation strategy comprises selecting an angle-control mode, and wherein computing the control value for the angle-control mode comprises: selecting the downstream steering angle value from the downstream steering angle sensor as a target angle, selecting the TAS angle value from the TAS as a feedback angle, and computing an angle error based on a difference between the target angle and the feedback angle; wherein generating the command signal for the angle control mode comprises generating the command signal for the steering actuator based on the angle error.
